(19) United States
(12) Patent Application Publication
(10) Pub. No.: US 2009/0323106 A1
(43) Pub. Date: Dec. 31, 2009

(54) IMAGE PROCESSING SYSTEM, METHOD FOR CONTROLLING THE SAME, AND RECORDING MEDIUM STORING PROGRAM CODE THAT CAUSES THE IMAGE PROCESSING SYSTEM TO EXECUTE THE METHOD

(76) Inventor: Satoshi SUGA, Yokohama-shi (JP)

Correspondence Address: OBLON, SPIVAK, MCCLELLAND MAIER & NEUSTADT, L.L.P., 1940 DUKE STREET, ALEXANDRIA, VA, 22314, US

(21) Appl. No.: 12/487,788

(22) Filed: Jun. 19, 2009

(30) Foreign Application Priority Data
Jun. 25, 2008 (JP) 2008-165703

(51) Int. Cl. G06F 3/12

(52) U.S. Cl. 358/1.15

(57) ABSTRACT

An image processing system to perform image processing using an image processing device having a function appropriate for a request from a user. The image processing system includes multiple image processing devices each having a different function and connected to a network, a function data storage unit to store function data of each of the multiple image processing devices, a unit to compare the function data stored in the function data storage unit with the request input by the user to obtain a function not implemented in the image processing system, and a display unit to display the function not implemented in the image processing system.

### CROSS-REFERENCE TO RELATED APPLICATIONS

The present patent application is based on and claims priority pursuant to 35 U.S.C. §119 from Japanese Patent Application No. 2008-165703, filed on Jun. 25, 2008 in the Japan Patent Office, the entire contents of which are incorporated herein by reference.

### BACKGROUND OF THE INVENTION

1. Field of the Invention

Exemplary aspects of the present invention generally relate to an image processing system including multiple image processing devices each connected to a network to perform image processing by selecting an image processing device from the multiple image processing devices appropriate for an image processing request from a user, a method for controlling the image processing system, and a recording medium storing program code that causes the image processing system to execute the method.

2. Description of the Background

Recent promotion of computerization makes image processing devices such as printers, facsimile machines, and copiers essential to output computerized data.

Further, recent improvements in networking now provide image processing systems including multiple image processing devices each connected to a network such as a local area network (LAN). One such image processing system includes a client device, a server device, and multiple image processing devices such as printers, each connected to the network. When a print request is sent from the client device, the server device checks the operating status of each of the image processing devices and distributes the print job to an appropriate image processing device.

However, because each of the image processing devices connected to the network in the above-described image processing system has the same function, there is no chance to select an appropriate image processing device that performs printing operations desired by the user. Further, in practice, because new image processing devices having new functions and upgraded performance quickly become available all the time, the image processing devices connected to the network are usually replaced with new image processing devices sequentially, that is, in order starting from the oldest model. This means that the above-described image processing system, in which the image processing devices each having the same function are connected to the network, is not widely used and therefore is not practical.

To solve this problem, an image processing system including multiple image processing devices each having different functions and capabilities and connected to a network to perform image processing using an image processing device having functions and capabilities appropriate for a request from a user has been proposed. As a result, an image processing function that is not implemented by a single image processing device can be implemented using the image processing system.

However, because the above-described image processing system does not take into consideration a case in which the functions and capabilities of the above-described image processing system are not appropriate for the request from the user, it is difficult to build a system environment desired by the user.

### SUMMARY

In view of the foregoing, illustrative embodiments of the present invention provide an image processing system including multiple image processing devices each having a different function and connected to a network to perform image processing using an image processing device having a function appropriate for a request from a user. The image processing system supports building a system environment to satisfy the request from the user even when the functions included in the image processing system do not correspond to the request from the user. Illustrative embodiments of the present invention also provide a method for controlling the image processing system, and a recording medium storing program code that causes the image processing system to execute the method.

In one illustrative embodiment, an image processing system to perform image processing using an image processing device having a function appropriate for a request from a user includes multiple image processing devices each having a different function and connected to a network, a function data storage unit to store function data of each of the multiple image processing devices, a unit to compare the function data stored in the function data storage unit with the request input by the user to obtain a function not implemented in the image processing system, and a display unit to display the function not implemented in the image processing system.

Another illustrative embodiment provides a method for controlling the image processing system described above. The method includes comparing function data of each of the multiple image processing devices prestored in the image processing system with the request input by the user to obtain a function not implemented in the image processing system, and displaying the function not implemented in the image processing system.

Yet another illustrative embodiment provides a recording medium storing program code that causes the image processing system described above to execute the method described above.

Additional features and advantages of the present invention will be more fully apparent from the following detailed description of illustrative embodiments, the accompanying drawings, and the associated claims.

### BRIEF DESCRIPTION OF THE DRAWINGS

A more complete appreciation of the disclosure and many of the attendant advantages thereof will be more readily obtained as the same becomes better understood by reference to the following detailed description of illustrative embodiments when considered in connection with the accompanying drawings, wherein:

FIG. 1 is a schematic diagram illustrating a configuration of an image processing system according to a first illustrative embodiment;

FIG. 2 is a block diagram illustrating a configuration of a scanner included in the image processing system according to the first illustrative embodiment;

FIG. 3 is a block diagram illustrating a configuration of a printer included in the image processing system according to the first illustrative embodiment;

FIG. 4 is a functional block diagram of the scanner shown in FIG. 2;

FIG. 5 is a diagram illustrating an example of a scanner profile;

FIG. 6 is a functional block diagram of the printer shown in FIG. 3;

FIG. 7 is a diagram illustrating an example of a printer profile;

FIG. 8 is a functional block diagram of a client PC included in the image processing system according to the first illustrative embodiment;

FIG. 9 is a diagram illustrating an example of multiple scanner data profiles stored in the client PC;

FIG. 10 is a diagram illustrating an example of multiple printer data profiles stored in the client PC;

FIG. 11 is a flowchart illustrating operations performed by a request interpretation unit included in the client PC when a desired function is input by a user through the client PC;

FIG. 12 is a flowchart illustrating operations performed by a request interpretation unit included in the scanner or an MFP device in the image processing system according to the first illustrative embodiment when the client PC requests scanner profiles;

FIG. 13 is a flowchart illustrating operations performed by a request interpretation unit included in the printer or the MFP device when the client PC requests printer profiles;

FIG. 14 is a schematic diagram illustrating a configuration of an image processing system according to a second illustrative embodiment;

FIG. 15 is a functional block diagram of a client PC included in the image processing system according to the second illustrative embodiment;

FIG. 16 is a functional block diagram of a server device included in the image processing system according to the second illustrative embodiment;

FIG. 17 is a diagram illustrating an example of multiple scanner data profiles stored in the server device shown in FIG. 16;

FIG. 18 is a diagram illustrating an example of multiple printer data profiles stored in the server device;

FIG. 19 is a flowchart illustrating operations performed by a request interpretation unit included in the client PC in the image processing system according to the second illustrative embodiment when a desired function is input by the user through the client PC; and

FIG. 20 is a flowchart illustrating operations performed by a request interpretation unit included in the server device when the client PC requests profiles.

### DETAILED DESCRIPTION OF ILLUSTRATIVE EMBODIMENTS

In describing illustrative embodiments illustrated in the drawings, specific terminology is employed for the sake of clarity. However, the disclosure of this patent specification is not intended to be limited to the specific terminology so selected, and it is to be understood that each specific element includes all technical equivalents that operate in a similar manner and achieve a similar result.

Illustrative embodiments of the present invention are now described below with reference to the accompanying drawings.

In a later-described comparative example, illustrative embodiment, and exemplary variation, for the sake of simplicity the same reference numerals will be given to identical constituent elements such as parts and materials having the same functions, and redundant descriptions thereof omitted unless otherwise required.

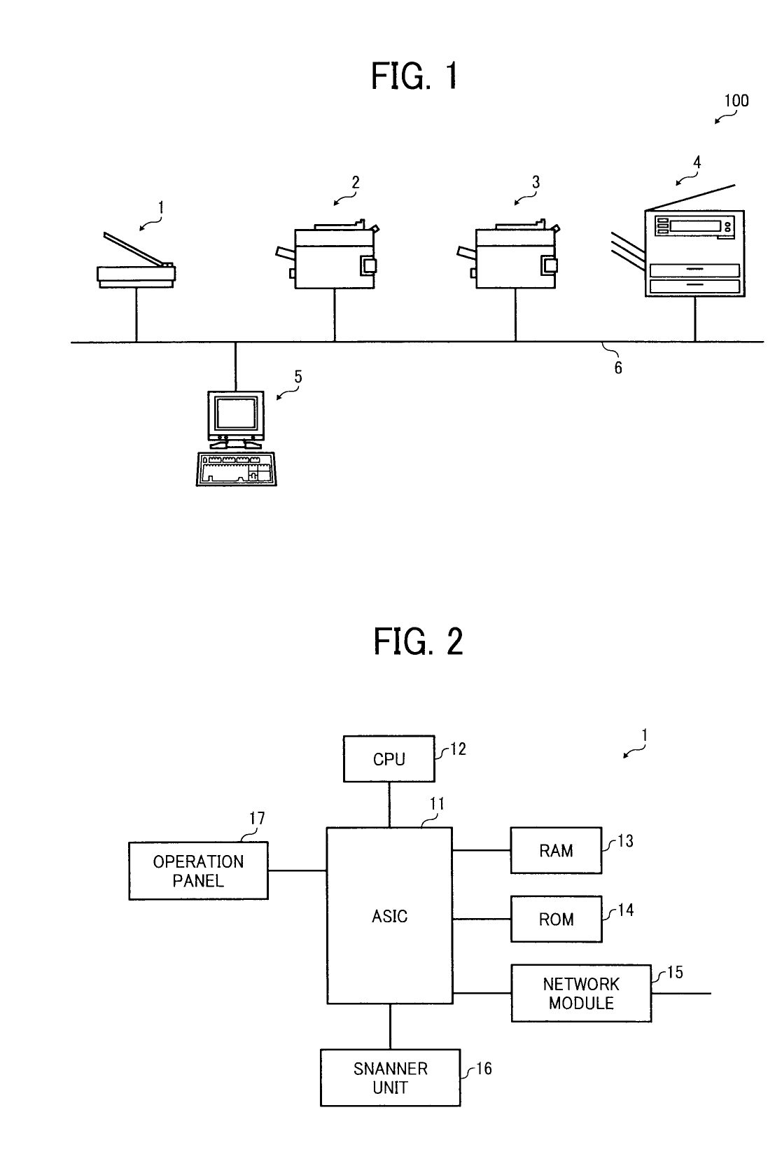

FIG. 1 is a schematic diagram illustrating a configuration of an image processing system 100 according to a first illustrative embodiment. The image processing system 100 includes a scanner 1, printers 2 and 3, a multifunction peripheral (MFP) device 4, and a client personal computer (PC) 5, each connected to a network 6 such as Ethernet®, a registered trademark of Xerox Corporation. Data are transferred among the scanner 1, the printers 2 and 3, the MFP device 4, and the client PC 5 through the network 6. It is to be noted that the number of scanners, printers, MFP devices, and client PCs included in the image processing system 100 is not limited to the number illustrated in FIG. 1.

FIG. 2 is a block diagram illustrating a configuration of the scanner 1. The scanner 1 includes an ASIC 11, a CPU 12, a RAM 13, a ROM 14, a network module 15, a scanner unit 16, and an operation panel 17. The ASIC 11 is connected to each of the CPU 12, the RAM 13, the ROM 14, the network module 15, the scanner unit 16, and the operation panel 17.

The CPU 12 reads programs from the ROM 14 to control the scanner 1. Further, the CPU 12 causes an operating system (OS) stored in the ROM 14 to control input and output of modules installed in the CPU 12 or various devices connected to the CPU 12 and to implement applications such as print processing and scanner processing.

The ASIC 11 is a custom IC including hardware to perform image processing, data input/output, and so forth. The ROM 14 stores the OS, programs, and data to control the scanner 1. The RAM 13 serves as a memory area for the CPU 12 to operate the programs. Although generally including a volatile memory, the RAM 13 often includes a smaller amount of nonvolatile memory.

The network module 15 is a module for communication between the scanner 1 and external devices such as a computer via the network 6. The scanner unit 16 serves as an optical reading mechanism to read images on documents or the like. The operation panel 17 receives operations input by a user and displays data to the user.

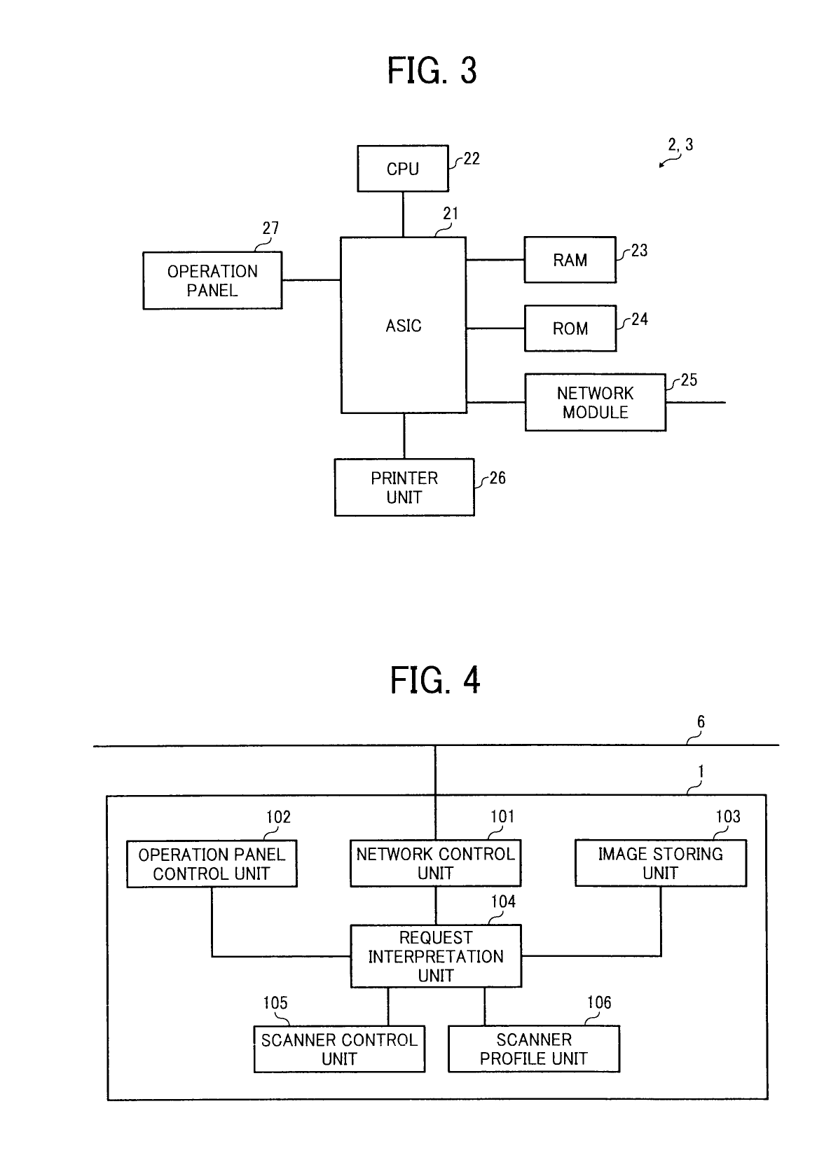

FIG. 3 a block diagram illustrating a configuration of the printer 2 or 3. Each of the printers 2 and 3 includes an ASIC 21, a CPU 22, a RAM 23, a ROM 24, a network module 25, a printer unit 26, and an operation panel 27. Similarly to the scanner 1 illustrated in FIG. 2, the ASIC 21 is connected to each of the CPU 22, the RAM 23, the ROM 24, the network module 25, the printer unit 26, and the operation panel 27. Specifically, in place of the scanner unit 16 of the scanner 1, each of the printers 2 and 3 includes the printer unit 26 serving as a printing mechanism. The ROM 24 stores programs and data to control the printer 2 or 3.

Although the drawing of the MFP device 4 is omitted, the MFP device 4 includes both the scanner unit 16 illustrated in FIG. 2 and the printer unit 26 illustrated in FIG. 3. A ROM provided in the MFP device 4 stores programs and data to control both scanner and printer functions of the MFP device 4.

The client PC 5 illustrated in FIG. 1 is a computer to control data of software stored therein and hardware such as a display and a keyboard connected to the client PC 5 using the software. Specifically, the client PC 5 serves as a front end of the image processing system 100 so that the user can input data or obtain processing results through a screen. Because a configuration of the client PC 5 is the same as that of generally-used computers, a drawing thereof is omitted.

FIG. 4 is a functional block diagram of the scanner 1. The functional block illustrated in FIG. 4 is implemented by each component illustrated in FIG. 2 and by running the OS and the application programs stored in the ROM 14 on the RAM 13.

Referring to FIG. 4, a network control unit 101 controls communication between the scanner 1 and the external devices on the network 6 such as the client PC 5. An operation panel control unit 102 transmits instructions from the user input through the operation panel 17 or a key to a request interpretation unit 104, and causes the operation panel 17 to display data output from the request interpretation unit 104. A scanner control unit 105 controls the scanner unit 16, and acquires image data to store the image data in an image storing unit 103. The request interpretation unit 104 distinguishes requests from the operation panel control unit 102 or from the external devices through the network control unit 101 and transmits instructions to each unit. A scanner profile unit 106 stores a scanner profile including data on reading performance of the scanner 1.

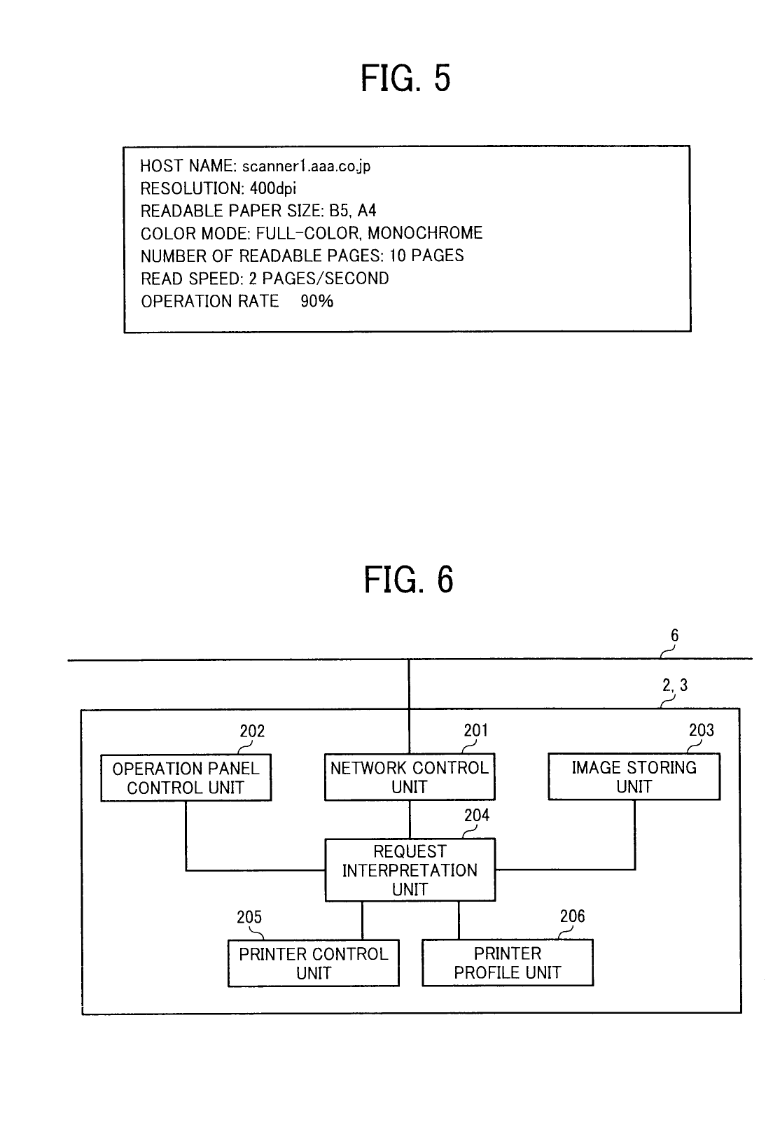

FIG. 5 is a diagram illustrating an example of the scanner profile. The scanner profile includes data such as a host name including a domain name indicating a position on the network 6, a resolution for reading data, a readable size of paper, a color mode, a number of continuously readable pages, a read speed, an operation rate, and so forth.

FIG. 6 is a functional block diagram of the printer 2 or 3. The functional block illustrated in FIG. 6 is implemented by each component illustrated in FIG. 3 and by running the OS and the application programs stored in the ROM 24 on the RAM 23.

Referring to FIG. 6, a network control unit 201 controls communication between the printer 2 or 3 and the external devices on the network 6 such as the client PC 5. An operation panel control unit 202 transmits instructions from the user input through the operation panel 27 or a key to a request interpretation unit 204, and causes the operation panel 27 to display data output from the request interpretation unit 204. An image storing unit 203 forms images based on a print job received from the network control unit 201, and stores the images. A printer control unit 205 controls the printer unit 26, and causes the printer unit 26 to print the images stored in the image storing unit 203. The request interpretation unit 204 distinguishes requests from the operation panel control unit 202 or from the external devices through the network control unit 201 and transmits instructions to each unit. A printer profile unit 206 stores a printer profile including data on print performance of the printer 2 or 3.

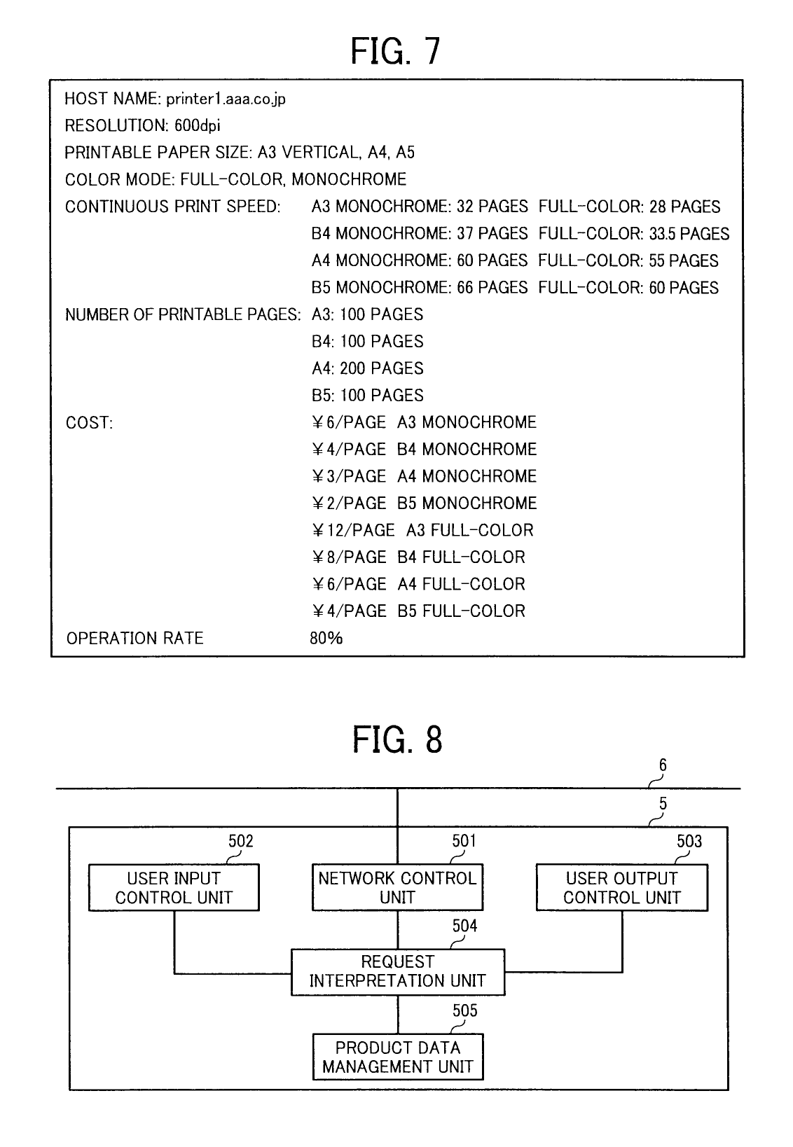

FIG. 7 is a diagram illustrating an example of the printer profile. The printer profile includes data such as a host name including a domain name indicating a position on the network 6, a resolution for printing data, a printable size of paper, a color mode, a continuous print speed, a number of paper set in a paper feed tray, costs for printing for each size of paper, an operation rate, and so forth.

FIG. 8 is a functional block diagram of the client PC 5. The functional block illustrated in FIG. 8 is implemented by each component in the client PC 5 and by running an OS and application programs stored in a ROM on a RAM.

Referring to FIG. 8, a network control unit 501 controls communication between the client PC 5 and the external devices on the network 6 such as the scanner 1. A user input control unit 502 transmits instructions from the user input through a keyboard or the like to a request interpretation unit 504. A user output control unit 503 causes the display or the like to display data output from the request interpretation unit 504 to prompt the user to input instructions, or to display the result to the user. The request interpretation unit 504 receives a request from the user sent from the user input control unit 502 and interprets the request to send the request to other devices through the network control unit 501, and receives a response from the other devices. Further, the request interpretation unit 504 processes the response thus received so that the response is displayed on the display through the user output control unit 503.

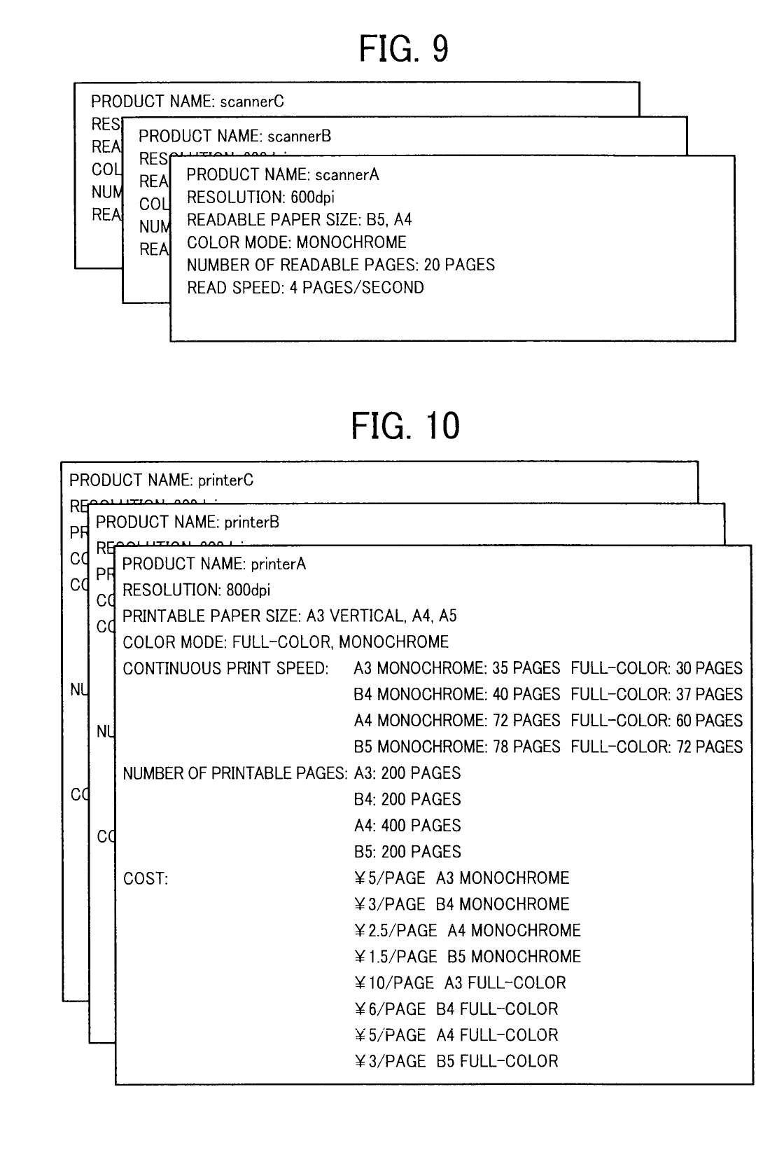

It is to be noted that the client PC 5 may include a product data management unit 505 to store multiple scanner data profiles illustrated in FIG. 9 and multiple printer data profiles illustrated in FIG. 10. Both the scanner data profile and the printer data profile include the same data as the scanner profile and the printer profile described above except for the operation rate.

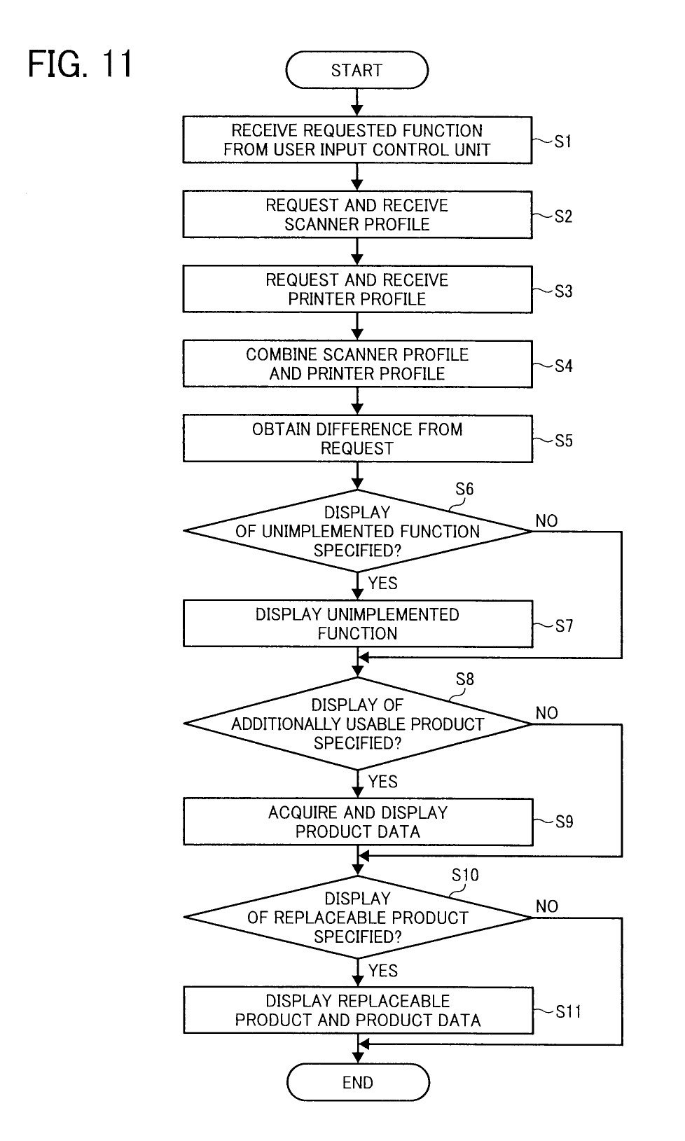

FIG. 11 is a flowchart illustrating operations performed by the request interpretation unit 504 when the user inputs a desired function through the client PC 5 of the image processing system 100 according to the first illustrative embodiment.

At S1, the request interpretation unit 504 receives a desired function input by the user through an input device such as a keyboard or a mouse from the user input control unit 502. For example, the request interpretation unit 504 receives data indicating that 200 sheets of A4-size paper are to be printed in full color with a resolution of 600 dpi as the desired function. At this time, how unimplemented functions are to be displayed is also specified. Specifically, the functions that are not implemented by the scanner 1, the printers 2 and 3, and the MFP device 4 may be simply displayed to the user. Alternatively, data on a product having the functions that are not implemented by the scanner 1, the printers 2 and 3, and the MFP device 4 (hereinafter referred to as an additionally usable product), or data on the image processing device to be replaced by a new product (hereinafter referred to as a replaceable product) may be displayed to the user. For facilitation, how the unimplemented functions are to be displayed may be specified using a menu format associated with the user output control unit 503.

Subsequently, at S2, the request interpretation unit 504 requests scanner profiles to the scanner 1 and the MFP device 4 on the network 6 through the network control unit 501, and receives the scanner profiles. At S3, the request interpretation unit 504 requests printer profiles from the printers 2 and 3 and the MFP device 4 on the network 6 through the network control unit 501, and receives the printer profiles. At S4, the request interpretation unit 504 combines the scanner profiles and the printer profiles thus received. At S5, the request interpretation unit 504 compares the scanner profiles and the printer profiles thus combined to the request from the user acquired at S1 to obtain a difference therebetween.

At S6, the request interpretation unit 504 determines whether or not display of the unimplemented functions is specified. When display of unimplemented functions is specified (YES at S6), the process proceeds to S7 to display the functions that are requested by the user at S1 and are not implemented by the scanner 1, the printers 2 and 3, and the MFP device 4 on the display or the like through the user output control unit 503.

When display of the unimplemented functions is not specified (NO at S6), the process proceeds to S8 to determine whether or not display of the additionally usable product is specified. When display of the additionally usable product is specified (YES at S8), the process proceeds to S9 so that the request interpretation unit 504 references the product data management unit 505 to acquire product data of a scanner or an MFP device including scanner functions not included in the scanner 1 and the MFP device 4, and product data of a printer or an MFP device including printer functions not included in the printers 2 and 3 and the MFP device 4. The product data thus acquired is displayed on the display or the like through the user output control unit 503.

When display of the additionally usable product is not specified (NO at S8), the process proceeds to S10 to determine whether or not display of the replaceable product is specified. When display of the replaceable product is specified (YES at S10), the process proceeds to S11 to extract a profile of the image processing device having a lower operation rate included in the image processing system 100 from the printer profiles and the scanner profiles. The request interpretation unit 504 combines the profile of such an image processing device and the functions not implemented by the scanner 1, the printers 2 and 3, and the MFP device 4 to acquire product data of an introducible image processing device including the functions that are not implemented by the scanner 1, the printers 2 and 3, and the MFP device 4 from the product data management unit 505. The product data of the introducible image processing device thus acquired is displayed together with data on a target image processing device to be replaced by the introducible image processing device on the display or the like through the user output control unit 503.

It is to be noted that, at S11, alternatively, the request interpretation unit 504 may extract the printer profile of the image processing device with higher printing costs included in the image processing system 100. Thereafter, the request interpretation unit 504 combines the printer profile of such an image processing device and the functions not included in the scanner 1, the printers 2 and 3, and the MFP device 4 to acquire product data of a introducible image processing device including the functions that are not included in the scanner 1, the printers 2 and 3, and the MFP device 4 from the product data management unit 505.

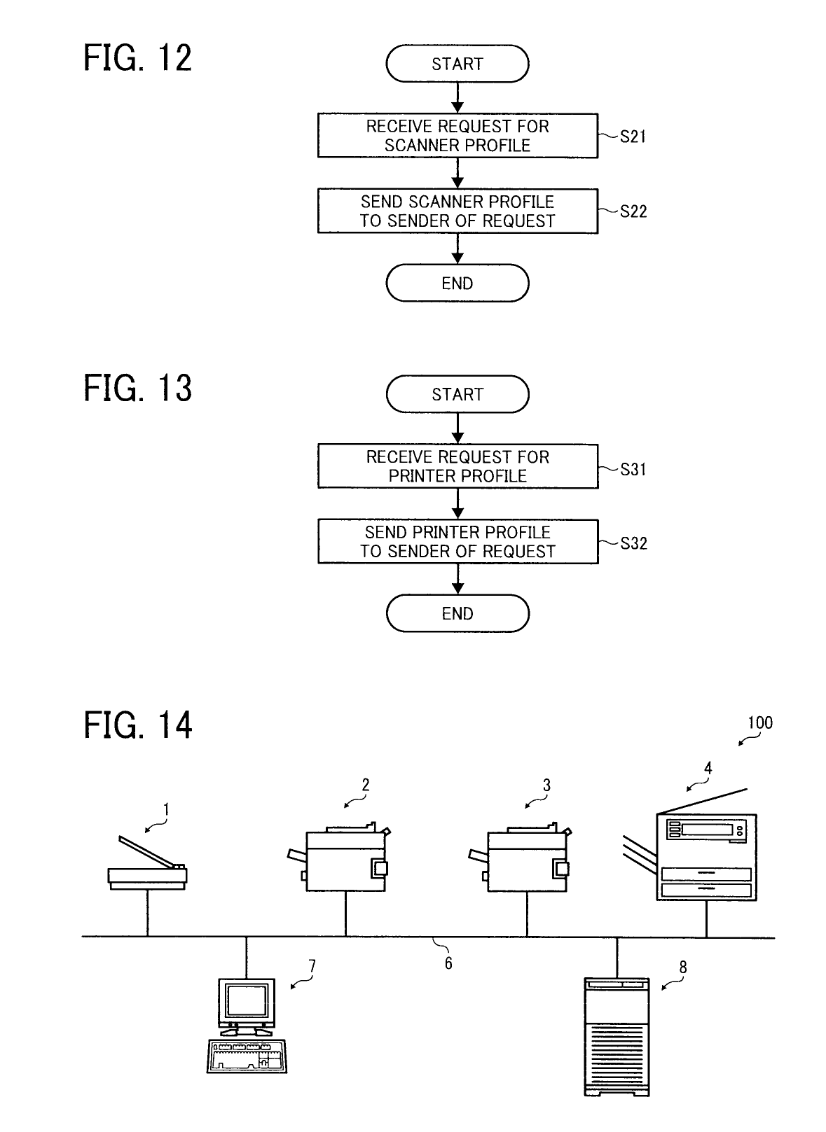

FIG. 12 is a flowchart illustrating operations performed by the request interpretation unit 104 included in the scanner 1 or the MFP device 4 when the client PC 5 requests the scanner profile at S2 in FIG. 11.

At S21, the request interpretation unit 104 receives a request for the scanner profile sent from the client PC 5 through the network 6. At S22, the request interpretation unit 104 extracts the scanner profile from the scanner profile unit 106 to send the scanner profile to the client PC 5 through the network 6.

FIG. 13 is a flowchart illustrating operations performed by the request interpretation unit 204 included in the printer 2 or 3 or the MFP device 4 when the client PC 5 requests the printer profile at S3 in FIG. 11.

At S31, the request interpretation unit 204 receives a request for the printer profile sent from the client PC 5 through the network 6. At S32, the request interpretation unit 204 extracts the printer profile from the printer profile unit 206 to send the printer profile to the client PC 5 through the network 6.

As described above, in the image processing system 100 according to the first illustrative embodiment, when the desired function is input by the user through the client PC 5, functions that are not implemented by the scanner 1, the printers 2 and 3, and the MFP device 4 on the network 6 are extracted and displayed to the user. In addition, the client PC 5 includes the product data so that the additionally usable image processing device including the functions not implemented by the scanner 1, the printers 2 and 3, and the MFP device 4 is displayed to the user. Further, data on printing costs is included in the profile of each image processing device so that the target image processing device to be replaced is displayed to the user together with the introducible image processing device. The profile of each image processing device also includes data on the operation rate so that the image processing device with a lower operation rate, that is, the target image processing device to be replaced, and the introducible image processing device are displayed to the user.

A description is now given of the image processing system 100 according to a second illustrative embodiment.

FIG. 14 is a schematic diagram illustrating a configuration of the image processing system 100 according to the second illustrative embodiment. In FIG. 14, components that are the same as those illustrated in FIG. 1 are denoted by the same reference numerals as FIG. 1. Differences from the first illustrative embodiment are that a server device 8 is added to the network 6 and a client PC 7 is provided in place of the client PC 5.

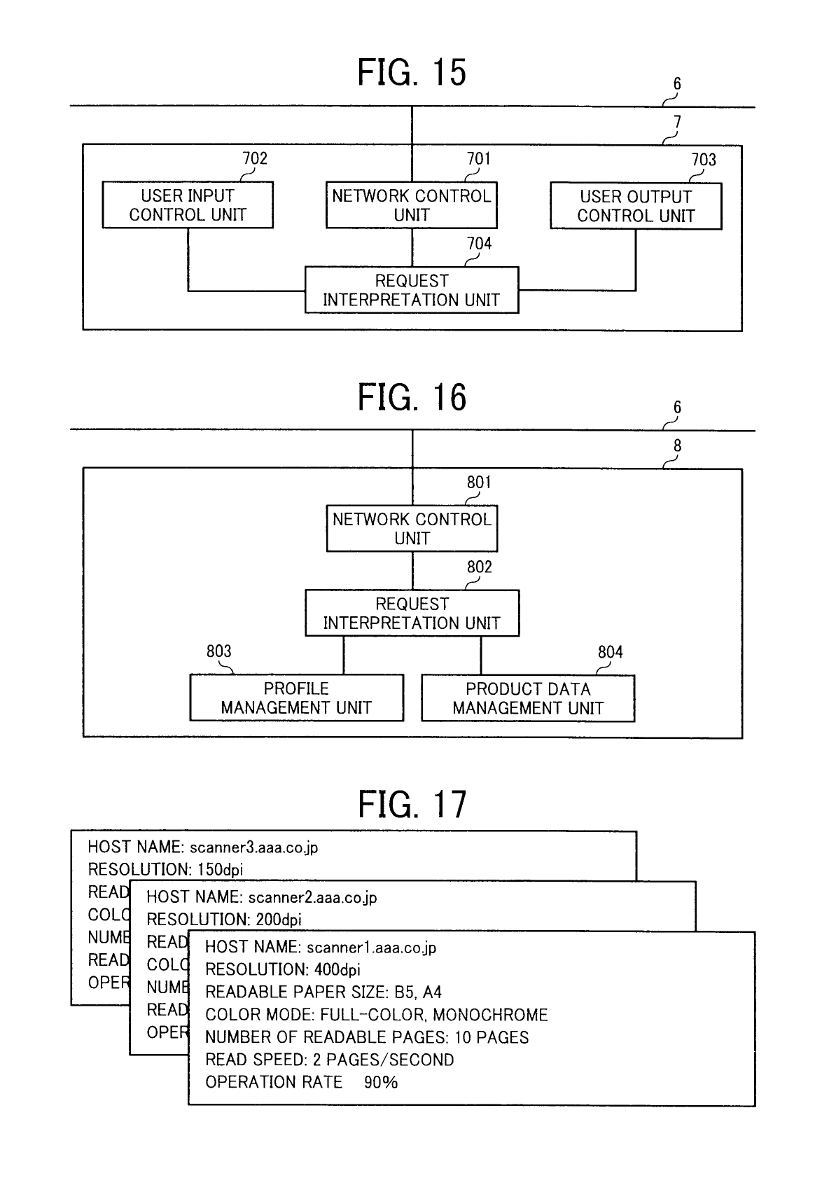

FIG. 15 is a functional block diagram of the client PC 7. The functional block illustrated in FIG. 15 is implemented by each component in the client PC 7 and by running an OS and application programs stored in a ROM on a RAM in the client PC 7. Referring to FIG. 15, the client PC 7 includes a network control unit 701, a user input control unit 702, a user output control unit 703, and a request interpretation unit 704. The above-described units function similarly to the network control unit 501, the user input control unit 502, the user output control unit 503, and the request interpretation unit 504 illustrated in FIG. 8, respectively. In other words, the difference between the client PC 7 according to the second illustrative embodiment and the client PC 5 according to the first illustrative embodiment is that a unit corresponding to the product data management unit 505 is not provided in the client PC 7.

FIG. 16 is a functional block diagram of the server device 8. Referring to FIG. 16, a network control unit 801 controls communication between the server device 8 and external devices on the network 6 such as the client PC 7. A request interpretation unit 802 receives a request from the external devices on the network 6, and interprets and processes the request to send the processed data to the other image processing devices via the network control unit 801. A profile management unit 803 stores scanner profiles and printer profiles of each of the image processing devices included in the image processing system 100, that is, the scanner 1, the printers 2 and 3, and the MFP device 4. A product data management unit 804 stores multiple scanner data profiles and multiple printer data profiles in the same manner as the product data management unit 505 illustrated in FIG. 8.

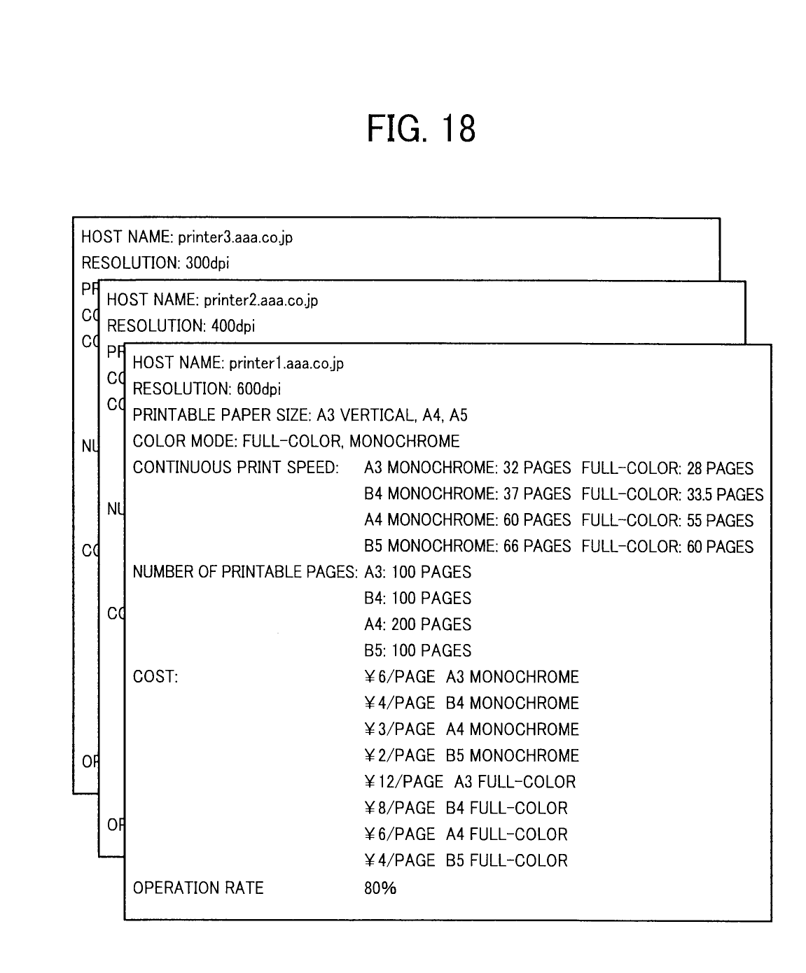

FIG. 17 is a diagram illustrating an example of the multiple scanner profiles stored in the profile management unit 803. FIG. 18 is a diagram illustrating an example of the multiple printer profiles stored in the profile management unit 803. Similarly to the scanner data profiles illustrated in FIG. 9 and the printer data profiles illustrated in FIG. 10 respectively stored in the product data management unit 505 illustrated in FIG. 8, the multiple scanner data profiles and the multiple printer data profiles stored in the product data management unit 804 include the same data included in the scanner profiles illustrated in FIG. 17 and the printer profiles illustrated in FIG. 18 except that the data on the operation rate is not included.

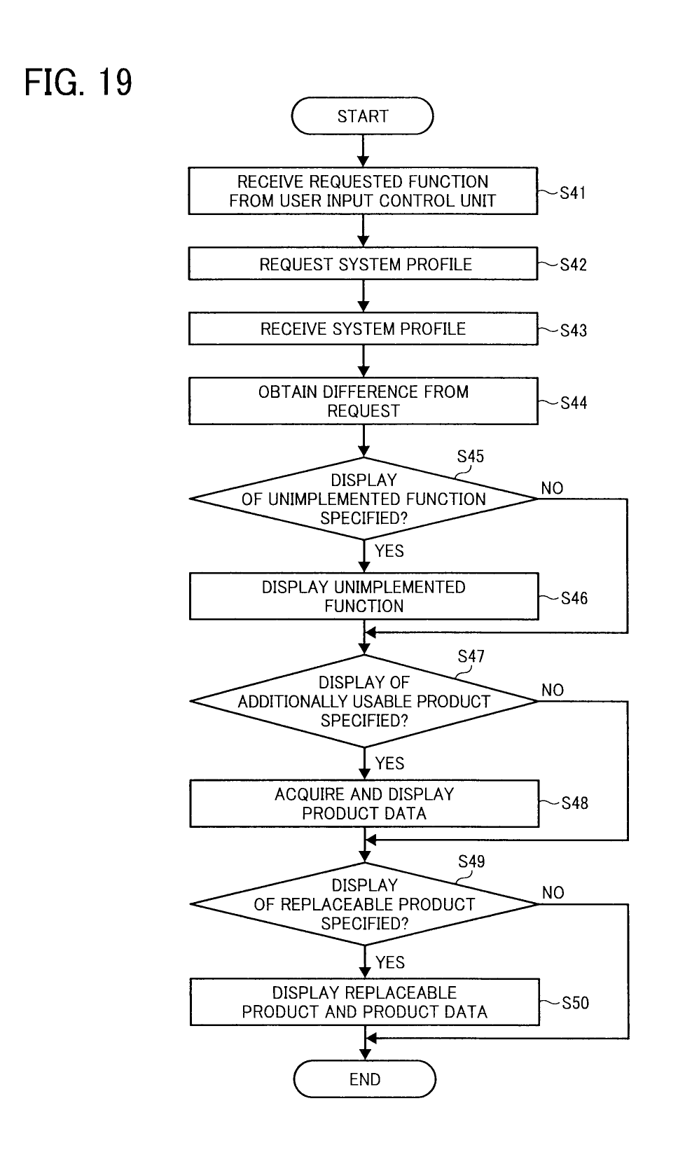

FIG. 19 is a flowchart illustrating operations performed by the request interpretation unit 704 when a desired function is input by the user through the client PC 7.

At S41, the process performed at S1 in FIG. 11 is performed. Specifically, at S41, the request interpretation unit 704 receives a desired function input by the user through an input device such as a keyboard or a mouse from the user input control unit 702. At S42, the request interpretation unit 704 requests from the server device 8 on the network 6 through the network control unit 701 a system profile in which the profiles of each image processing device in the image processing system 100 are combined together. At S43, the request interpretation unit 704 receives the system profile from the server device 8. At S44, the request interpretation unit 704 compares the system profile to the request from the user received at S41 to obtain a difference therebetween. Processes thereafter from S45 to S50 are the same as S6 to S11 illustrated in FIG. 11.

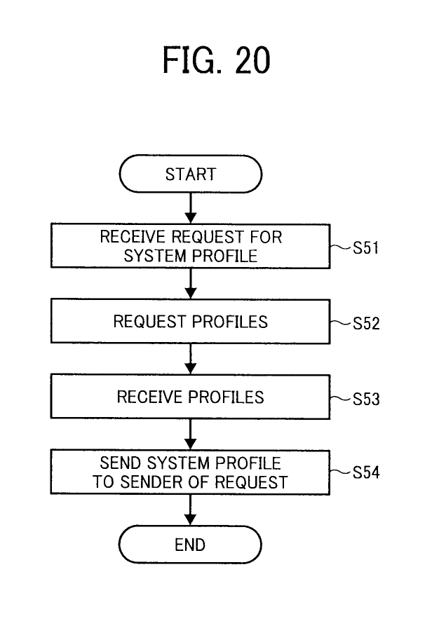

FIG. 20 is a flowchart illustrating operations performed by the request interpretation unit 802 included in the server device 8 when the client PC 7 requests the system profile at S42 in FIG. 19.

At S51, the request interpretation unit 802 receives a request for the system profile sent from the client PC 7 through the network 6. At S52, the request interpretation unit 802 requests the scanner profile from the scanner 1, the printer profiles from the printers 2 and 3, and both the scanner and printer profiles from the MFP device 4.

In response to the request, the scanner 1, the printers 2 and 3, and the MFP device 4 perform similarly to the processes illustrated in FIGS. 12 and 13, respectively, to send the profiles thus requested to the server device 8. Accordingly, at S53, the request interpretation unit 802 receives the profiles sent from each image processing device and stores the profiles in the profile management unit 803.

At S54, the request interpretation unit 802 extracts the scanner profiles and the printer profiles from the profile management unit 803 and combines the scanner profiles and the printer profiles to create a system profile. The system profile is sent to the client PC 7 through the network 6.

As described above, in the image processing system 100 according to the second illustrative embodiment, the profiles are stored in the server device 8. As a result, even in a case in which one of the image processing devices in the image processing system 100 is temporarily unavailable, functions that are not implemented by the scanner 1, the printers 2 and 3, and the MFP device 4 are extracted and displayed to the user when the desired function is input by the user through the client PC 7. In addition, faster processing speed can be achieved.

The product data is also stored in the server device 8 so that an image processing device including the functions that are not implemented by the scanner 1, the printers 2 and 3, and the MFP device 4 can be displayed to the user.

Further, data on printing costs is included in the profiles of each image processing device stored in the server device 8, so that data on the target image processing device to be replaced is displayed to the user together with data on an introducible image processing device. The profiles of each image processing device stored in the server device 8 also include data on the operation rate so that data on the image processing device with a lower operation rate, that is, the target image processing device to be replaced, and data on the introducible image processing device are displayed together to the user.

In the foregoing illustrative embodiments, the client PC and the server device are included in the image processing system. Alternatively, a printer, a scanner, or an MFP device may be used in place of the client PC and the server device as long as the printer, the scanner, or the MFP device includes the request interpretation unit, the profile unit, and the product data management unit like those described above.

Elements and/or features of different illustrative embodiments may be combined with each other and/or substituted for each other within the scope of this disclosure and appended claims.

Illustrative embodiments being thus described, it will be apparent that the same may be varied in many ways. Such exemplary variations are not to be regarded as a departure from the scope of the present invention, and all such modifications as would be obvious to one skilled in the art are intended to be included within the scope of the following claims.

The number of constituent elements and their locations, shapes, and so forth are not limited to any of the structure for performing the methodology illustrated in the drawings.

What is claimed is:

1. An image processing system to perform image processing using an image processing device having a function appropriate for a request from a user, the image processing system comprising:
multiple image processing devices each having a different function and connected to a network;
a function data storage unit to store function data of each of the multiple image processing devices;
a unit to compare the function data stored in the function data storage unit with the request input by the user to obtain a function not implemented in the image processing system; and
a display unit to display the function not implemented in the image processing system.

2. The image processing system according to claim 1, further comprising:
a product data storage unit to store product data of an image processing device introducible to the image processing system and function data of the introducible image processing device associated with the product data;
a product data extracting unit to extract product data of an image processing device having the function not implemented in the image processing system from the product data storage unit; and
a display unit to display the product data thus extracted.

3. The image processing system according to claim 2, further comprising:
a replaceable device selection unit to select a target image processing device to be replaced by the introducible image processing device having the extracted product data; and
a display unit to display the target image processing device thus selected.

4. The image processing system according to claim 3, further comprising a unit to store cost data of each of the multiple image processing devices included in the image processing system,
wherein the replaceable device selection unit selects an image processing device having the highest cost data among the multiple image processing devices.

5. The image processing system according to claim 3, further comprising an operation rate data storage unit to store data on an operation rate of each of the multiple image processing devices included in the image processing system,
wherein the replaceable device selection unit selects an image processing device having the lowest operation rate among the multiple image processing devices.

6. A method for controlling an image processing system comprising multiple image processing devices each having a different function and connected to a network to perform image processing using an image processing device having a function appropriate for a request from a user, the method comprising:
comparing function data of each of the multiple image processing devices prestored in the image processing system with the request input by the user to obtain a function not implemented in the image processing system; and
displaying the function not implemented in the image processing system.

7. The method for controlling an image processing system according to claim 6, the method further comprising:
referencing product data of an image processing device introducible to the image processing system and function data of the introducible image processing device each prestored in the image processing system to extract product data of an image processing device having the function not implemented in the image processing system; and
displaying the product data thus extracted.

8. The method for controlling an image processing system according to claim 7, the method further comprising:
selecting a target image processing device to be replaced by the introducible image processing device having the extracted product data; and
displaying the image processing device thus selected.

9. A recording medium storing program code that causes an image processing system comprising multiple image processing devices each having a different function and connected to a network to perform image processing using an image processing device having a function appropriate for a request from a user to execute a method for controlling the image processing system, the method comprising:
comparing function data of each of the multiple image processing devices prestored in the image processing system with the request input by the user to obtain a function not implemented in the image processing system; and
displaying the function not implemented in the image processing system.
